(19) United States
(12) Patent Application Publication
(10) Pub. No.: US 2006/0098833 A1
(43) Pub. Date: May 11, 2006

(54) Self forming in-the-ear hearing aid

(76) Inventors: Roger P. Juneau, Destrehan, LA (US); Brian Tanner, Destrehan, LA (US); Edward J. Desporte, Covington, LA (US); Michael Major, Mandeville, LA (US); Gregory R. Siegle, Kenner, LA (US)

Correspondence Address: GARVEY, SMITH, NEHRBASS & DOODY, L.L.C., Suite 3290, 3838 N. Causeway Blvd., Metairie, LA, 70002, US

(21) Appl. No.: 11/138,540

(22) Filed: May 26, 2005

Related U.S. Application Data
(60) Provisional application No. 60/575,533, filed on May 28, 2004.

(51) Int. Cl. H04R 25/00

(52) U.S. Cl. 381/328; 381/322; 381/324

(57) ABSTRACT

A soft-solid ear piece is formed to fit the typical human ear canal and will self form to fill the ear cavity by having an internal structure, endoskeleton, or bladder to expand to precisely fit the ear piece securely and comfortably in the ear canal. This self forming ear piece will enable ready-ware and custom molded hearing aids, hearing protectors, audio ear pieces, cell phone ear pieces and assistive listening devices to fit comfortably, securely, and free of acoustic feedback in the external ear canal. It creates an acoustic seal to optimally reduce peripheral leakage and intermodulation distortion delivering excellent acoustic performance while keeping environmental sounds blocked out.

### CROSS-REFERENCE TO RELATED APPLICATIONS

Priority of U.S. Provisional Patent Application Ser. No. 60/575,533, filed May 28, 2004, incorporated herein by reference, is hereby claimed.

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

1. Field of the Invention

The present invention relates to hearing devices. More particularly, the present invention relates to in-the-canal hearing devices, wherein a metallic frame expands responsive to body temperature when inserted into the ear canal to ensure a good fit.

2. General Background of the Invention

The hearing industry has desired a one size fits most ear piece to efficiently serve the hearing impaired for many years. Industrial audiologists have also advocated a one-size-fits-most to serve in the hearing protection and communication needs in industry, sport shooting, and military applications. This device has eluded engineers and researchers because the human ear canal is dynamic in nature and is anatomically variant between subjects (indeed, variant from ear to ear).

Each ear canal shape is unique in size, in the directional bend into the head, in geometrical shape (i.e., circular vs. elliptical cross section), and in sensitivity to contact pressure (in the form of a plugged up feeling, in sensations pain, or in reactions of coughing or sneezing). These anatomical variations are a fit problem in combination with dynamic action of the ear canal caused by the rolling, medial to lateral motion of the temperomandibular joint (TMJ) during the opening closing ones mouth. Research has demonstrated that dynamic action of the anterior-posterior plane of the ear canal will vary by about three to five millimeters during talking, chewing, or laughing. These factors, along with the fact that the ear canal slopes upward along the medial plane, deleteriously affect efforts to maintain an acoustic seal in the external ear canal in normal, daily operation of a hearing device.

The challenge to one-size-fits-most is heightened by the secretions of cerumen, oils, and moisture impeding electronic performance and life cycle. The chemical make up of cerumen alone is as individual as the ear in which the end product will reside. Cerumen may vary in acidity, as well as in the content of lipids, proteins, cholesterols, and waxy esters. The content latter component will, in fact, determine whether a wearer's cerumen is “wet” or “dry” in nature, each of which presents a different problem for hearing instrument longevity.

From a psycho-acoustic perspective the location and pressure of the acoustic seal is very important. Poor placement will cause a sense of occlusion or stuffiness in the ear. The occlusion effect is the result of soft-tissue-conducted sounds that create an internal sound level greater than 10-12 dB above the ambient (or “out-side” of the head) sound levels. When this occurs, wearers report their own voice sounds funny, hollow, or as if their heads are in barrels. This is commonly caused by too tight an acoustic seal on soft tissue between the aperture medially to the first directional bend of the external ear canal. Occlusion effect is further heightened by varied peripheral or “slit leakage” and poor or no venting. The slit leakage facilitates annoying low frequency resonation and distorts the mid-frequency sounds. Conversely, these problems are best managed with good venting and uniform acoustic seal.

When the acoustic seal is created properly at a point in the ear canal where there is a balance of cartilaginous and bony material, there is less slit leakage, sound is natural, and acoustic feedback is avoided. By adding a well designed vent system to allow excess low frequency sound energy to roll-off, and undesireably high ear canal air pressure to be released, the hearing device is optimized in all applications. The over-all performance of the device can then yield better sound quality and “distinctness of sounds.”

With the goal of high fidelity amplification in both custom and non-custom hearing instruments, entailing a 20-20,000 Hz frequency response, a dynamic, secure, yet comfortable acoustic seal is paramount.

All previous efforts to achieve this type of fit have revolved around the concept of building up the exterior of the hearing instrument, making a “tighter” fit. This approach, unfortunately, was the only avenue available with those instruments composed of rigid, non-compliant acrylic.

The traditional shell molded from an individual's unique ear impression has not yielded a truly typical form that anatomically fits a significant percentage of any external ear category. It is further limited by a dated acrylic design which is the most commonly used shell technology. This technology was adopted from dental industry in the 1960's. It has a Shore Hardness factor of 90 Durometer. Little design change has been introduced since its development. Production and curing techniques have improved, however, through laser modeling and 3-D imaging. Since the ear is a dynamic acoustic environment and is ill-served by a rigid material like acrylic. The material however has a reasonable life cycle in the environment of the ear. Hard Durometer devices rock in the ear with jaw motion (TMJ), as opposed to flexing and accommodating the dynamic action of the ear.

Attempts with soft hollow shell technology have failed based on several key issues: Most soft material shrinks, discolors (usually unsightly yellow or brown), hardens after a few months.

Silicone based materials, which are preferred to be used in the body, are incompatible for bonding to the typical electronic faceplate. Soft/hollow materials tend to collapse upon insertion and deform over time loosing their ability to create an acoustic seal.

Foam technology typically requires multiple sizes to achieve a fit. They are uncomfortable, stuffy, and should not be reused as cellular foam becomes a breeding ground for bacteria.

The following U.S. patents are each hereby incorporated herein by reference:

U.S. Pat. No. 6,478,656 Method and apparatus for expanding soft tissue with shape memory alloys; This patent describes the application of a body worn bra where by the soft tissue of the skin forming the breast is expanded by incorporating an adhesive and an appliance with a shape memory alloy.

U.S. Pat. No. 6,135,235 discloses a self-cleaning cerumen guard for a hearing device.

U.S. Pat. No. 5,999,859 discloses a apparatus and method for perimodiolar cochlear implant with retro-positioning.

U.S. Pat. No. 5,977,689 discloses a biocompatible, implantable hearing aid microactuator.

U.S. Pat. No. 5,800,500 discloses a cochlear implant with shape memory material and method for implanting the same.

U.S. Pat. No. 5,772,575 discloses an implantable hearing aid.

U.S. Pat. No. 5,630,839 discloses a multi-electrode cochlear implant and method of manufacturing the same.

U.S. Pat. No. 4,762,135 discloses a cochlea implant.

U.S. Pat. No. 3,865,998 discloses an ear seal. This patent states that the typical cross section of the external ear canal is best approximated by a super ellipse which is defined by the equation.
(x/a)ⁿ+(y/b)ⁿ=1 where n=2.4.

The hypothesis is that an ear seal could be created using a soft material with an outer periphery defined by the super elliptic shape. The patent does not address the bigger issues associated with the longitudinal axes formed by extending a line through the medial-lateral plane or the dynamic nature of the TMJ. The latter issue was neglected because the device was very short by today's standards for insertion. The patent also did not consider the surface pressure necessary to create the acoustic seal it desired to deliver. In essence it was a tapered flanged silicone plug of super ellipse cross section.

Nitinol wire is used in a variety of medical and nonmedical device applications including guide wires, catheters, stents, filters, orthodontic appliances, eyeglass frames, cellular phone antennae and fishing tackle, to name a few.

Because shape memory and super elasticity are very temperature dependent, the fully annealed austenitic peak temperature is used to classify Nitinol to set the transformation temperature at which the Nitinol material has completely transformed to its memory shape or below which, exhibits malleable, ductile characteristics.

Of the many mechanical properties unique to Nitinol, two critical characteristics exhibited in the austenitic phase are the loading plateau and the unloading plateau, usually diagrammed on a stress/strain curve. The loading plateau is the stress level at which material produces an almost constant stress level over a relatively large range of strain, up to about 8%. Stainless steel conversely, does not exhibit this property of constant stress after 0.3% of strain. Other information relating to Nitinol can be found at www.nitinol.com.

### BRIEF SUMMARY OF THE INVENTION

The present invention provides a unique self-forming device to the individual external ear canal employing a metallic frame, preferably of the Nitinol family of alloys. The current preferred Nitinol is comprised of near equiatomic percentages of nickel and titanium, such as Memry Corporation tube stock BB-196X230.

Nitinol exhibits a thermoelastic transformation. This transformation is responsible for either shape memory or super elasticity being exhibited by the alloy on the respective side of the target temperature. Following deformation below the transformation range, the property called “shape memory” allows recovery of a predetermined shape upon heating above the transformation range. Super elasticity is the non linear recoverable deformation behavior at temperatures above the austenitic finish (Af) temperature, which arises from the stress-induced martensitic transformation on loading and the reversion of transformation upon unloading. Coronary stents utilize this technology as a recovery mechanism once deformed and inserted through a catheter. The Nitinol alloy is strong and resilient. The strain recovered with shape memory or super elasticity typically provides nearly ten times the elastic spring back of other alloys such as stainless steel. Additionally, Nitinol has excellent biocompatibility properties.

The austenitic and martensitic characteristics of a Nitinol endoskeleton, in concert with a soft-solid silicone body, acts to create an easily inserted ready-wear ear device which will self form to the shape of the external ear canal, establishing a precise wall pressure. Simply stated, a small soft device with the endoskeleton grows once inserted into the ear canal. It may transform by heat, electrical current, or other means. As it grows (i.e. recovers from deformation to the pre-molded shape) to sufficient size, the ear worn device resides in equilibrium, comfortably and securely in the ear. The endoskeleton can be shaped similar to a human rib cage. This anatomical choice allows the device to expand like the chest cavity breathing. The particular design more closely follows that of an eel or snake rib cage. This makes the instrument self-seeking during insertion as it snakes through the directional bends of the ear canal.

The present invention provides a hearing device or hearing aid or hearing protector with a Nitinol endoskeleton in a soft silicone body that will enhance the fitting of pediatric and young children, who have been relegated to wearing behind-the-ear appliances that are routinely taped to the heads of the young wearers. In the past, parents have objected to this practice, but are typically faced with no alternatives. Small in-the-ear hearing devices can, with this invention, be manufactured with an endoskeleton, extending the proper fit of the device by several months. This enables the commercialization of a new generation hearing device uniquely suited for children. Today, children outgrow acrylic devices. They are often outgrown too quickly to be cost effective.

Advanced self-forming endoskeleton technology will eventually achieve a customer satisfaction ratings of 80-90%. Advances in shell technology incorporating soft-solid bodies with endoskeletons manufactured from memory-metal technology will make it possible to mass-produce instruments that will provide a secure, comfortable fit rivaling custom-fit instruments. This will result in better over-all sound performance and cost reductions based on mass production techniques. Significant savings will be realized at all levels of the current hearing aid delivery system. The need to make ear impressions will be greatly reduced, eliminating the need to send those impressions into a laboratory. In those cases where ear impressions are necessary, the application of shape memory technology will yield a more predictable fit in the custom-molded embodiment.

Post-fitting care will be greatly improved in that a replacement or loaner device is readily available to the patient. This alone will reduce office visits for the patient and eliminate overnight delivery cost necessary to meet patient expectations on an important medical, audio, or communications device.

To the end this shape memory technology will lead to impression-less hearing aids for the vast majority of the hearing impaired market. Ready wear fittings will achieve levels of fit, comfort, security, and performance that will rival or exceed custom devices. These improvements will affect all devices intended to be inserted into the ear for sound delivery and voice pickup.

Voice pickup technology, through the use of subminiature electret microphones a piezoelectric accelerometers (similar to the Endevco Model 22 PICOMIN™), or a MEMS accelerometers, facilitates communication through hard wired or wireless platforms such as Blue Tooth or Zigbee. In turn, the acoustic system delivers incoming signals to the ear drum. For voice pickup the accelerometer is positioned between the external ear canal wall and the outer side of the stent in such a way as to create radial pressure between the ear canal and the accelerometer. This design could achieve hands free communication in many applications.

The design of a self-forming device is achieved by expanding the soft-solid device in a way that contact with the external ear canal wall is achieved by reaching equilibrium. Each surface point on the external ear canal wall, adjacent to the skeletal structure, will have forces on the canal wall where, F(a)=F(b)=F(c)=F(n). The shape of the extruded wire may be, for example, round or rectangular or of an I-beam cross-section. The cross-sectional shape and the cross sectional area of the members forming the endoskeleton, such as a stent or truss system, govern the amount of force that the endoskeleton will exert on the silicone embedding it. This force, by design, is equal to the elasticity of the surrounding silicone plus the required surface pressure necessary to bring the external surface of the device into contact with the wall of the external ear canal. This will establish an acoustic seal of known pressure. This, in turn, will accommodate a variety of ear canal shapes within the known range of deflection. This self regulating force will enable custom-molded devices to fit optimally and will enable ready-wear devices to accomplish one-size-fits-most in real world terms. The forces generated by the endoskeleton will be perpendicular to the ear canal wall, eliminating any shearing action on the skin.

The mechanics of the current device are driven by temperature change from room temperature to ear canal temperature. In another embodiment, the transformation is driven by an electrical current through the endoskeleton. This could be necessary in applications where room temperature is greater than ear canal temperature. Activation temperatures are metallurgically set. The following are exemplary endoskeleton material parameters for the memory metal (Nitinol, from Fort Wayne Metals Research Corporation):

1. Passive metal excited by temperature change:
i. EAC temperature @ 35° C.±1° C.
ii. T=10° C.±1° C. or 32° C.±3° C.

2. Active metal excited by an electrical current.
i. Electrical current will heat the Nitinol, causing transformation.

3. Attribute of Nitinol:
Will not interfere with hardware of wireless communication.

The endoskeleton extruded design can be a simple spring. The intended use is to pull on the proximal end of the device, there by reducing its cross sectional area and increasing its longitudinal dimension. Once inserted, the device returns the device to a diameter sealing the ear canal with uniform pressure. The Nitinol is molded as a star in its austenitic. The intended use is to compress the proximal end of the device on the endoskeleton, thereby reducing its cross sectional area. As the user inserts the device, its memory shape returns the device to a diameter sealing the ear canal with uniform pressure. A gradient wedge coil can be formed from extruded wire, molded into a coil with the thicker end to be placed near lateral end. A truss system can include members of cross-sectional shapes selected to optimize the deflection and force transferred to the ultimate excursion of the silicone device. The truss system shape is selected to accommodate a typical ear canal shape. Sinusoidal shapes of various cross-sectional sizes can be connected together to generate vector forces of precise angular change delivering optimum excursion of the endoskeleton. These designs are generally micro-machined from tubing, laser cut, and micro blasted to a polished finish.

The endoskeleton would ideally be of a shape to optimize acoustic seal, placed in the device to minimize the occlusion effect. The acoustic seal would be uniform on the canal wall three millimeters past the second directional bend. In power hearing device applications, the seal could be continuous from the aperture to three millimeters past the first directional bend.

The endoskeleton would also serve to further protect the delicate electronics.

### BRIEF DESCRIPTION OF THE DRAWINGS

For a further understanding of the present invention, reference should be had to the following detailed description, read in conjunction with the following drawings, wherein like reference numerals denote like elements and wherein:

FIG. 1 is a sectional view of the external ear canal of a wearer, wherein the out-of-ear embodiment of the in-the-ear device is in the malleable Martensite state which is deformed by bias spring to its smaller size, the device being easily inserted through the bends of the wearer's ear canal;

FIG. 2 is a perspective view of the preferred embodiment of the apparatus of the present invention shown positioned in the external ear canal thereby being exposed to body heat causing transformation from the Martensite phase to the Austenite Start (As) that starts recovery from the deformed shape to its annealed shape;

FIG. 3 is a perspective view of the preferred embodiment of the apparatus of the present invention shown in the recovered Austenite Finish (Af) state that transmits a radial force through the silicone body to the external ear canal wall yielding a comfortable, secure acoustic seal, free from acoustic feedback;

FIG. 4 is a perspective view of the preferred embodiment of the apparatus of the present invention showing the Nitinol stent portion that is in its molded state in the Austenite finish thus demonstrates the expanded size as shown in the device of FIG. 3;

FIG. 5 is an end view of the stent, taken along lines 5-5 of FIG. 4, wherein dimension (Dim.) A is in the major axis and dimension (Dim.) B is the minor axis;

FIG. 6 is a side view of the preferred embodiment of the apparatus of the present invention showing a Nitinol stent that is in its compressed or deformed state in the Martensite phase, the small size as in the device of FIG. 1;

FIG. 7 is a side sectioned view of the preferred embodiment of the apparatus of the present invention showing a Nitinol skeleton as a spring;

FIG. 8 is a side, sectioned view of the preferred embodiment of the apparatus of the present invention showing the Nitinol stent in the Austenite finish, wherein the expanded size creates pressure on an accelerometer, establishing a vibratory pathway from the ear canal wall so that the accelerometer picks up vibratory voice signals from the wearer to be transmitted to a communication device by a hard wire or a wireless system;

FIG. 9 is a perspective view of the preferred embodiment of the apparatus of the present invention showing a Nitinol stent characterized by rotating horseshoe cross sections that are in the molded state at the Austenite finish, (the expanded size when in the device of FIG. 3); and

FIGS. 10-14A are perspective views of the preferred embodiments of the apparatus of the present invention showing various Nitinol stent designs that are in its molded state in the Austenite finish (the expanded size when in the device illustrated in FIG. 3).

### DETAILED DESCRIPTION OF THE INVENTION

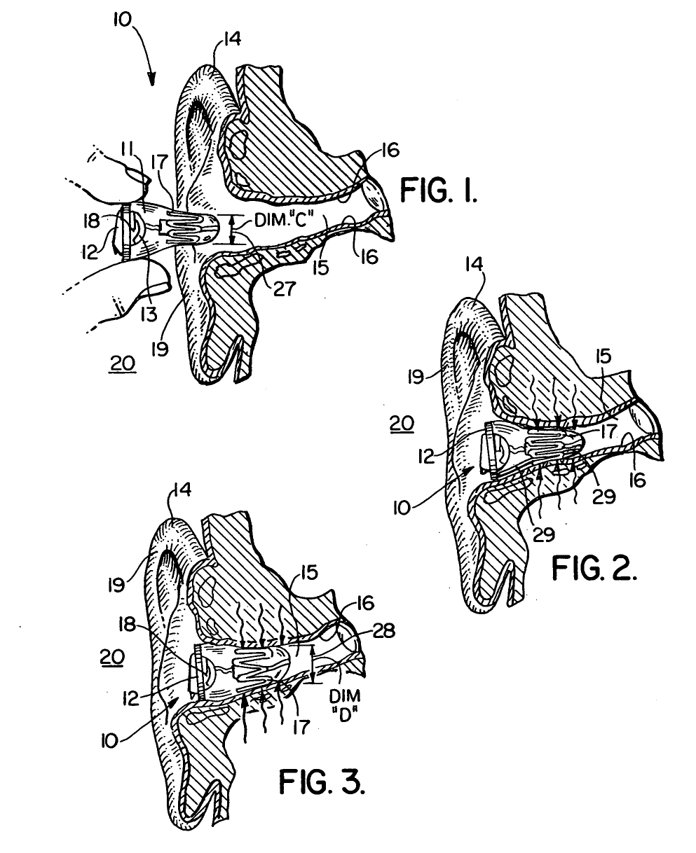

FIGS. 1-3 show generally the preferred embodiment of the apparatus of the present invention, designated generally by the numeral 10. Hearing device 10 has an internal stent or frame 17 that expands to its pre-molded state at human body temperature. In FIGS. 1-3 the practical application of apparatus 10 is an in the ear worn hearing aid, an active hearing protector, or a combination hearing protector hearing device, a passive hearing protector, a communication device, or a combination communication hearing and hearing protector device, or any combination sub-miniaturized into a single unit. As used herein, the term “hearing aid” is broadly construed to cover any of the above devices. Dim. C (arrow 27) of FIG. 1 is the smallest diameter of the device 10 in the malleable Martensite phase. The Nitinol preferably used to construct stent 17 will preferably reside in this state at typical room temperature below 30° C. The same malleable state may exist in the absence of a power signal for electrically driven stents. Illustrated by Dim. D (arrow 28) of FIG. 3 is the pre-molded diameter of the stent 17 for temperatures at or above 35° C. or when activated by an electrical signal for the active stents. Once completely inserted into a patient's ear canal 15 and expanded in the external ear canal 15, the device 10 achieves a precise peripheral seal with ear canal 15 wall 16 as shown in FIG. 3.

The hearing aid device 10 of FIG. 1 is characterized by a preferably flexible body 11 of soft silicone or other soft material compatible with ear canal 15 tissue. Hearing aid components 13 are also contained in body 11 and can include the battery compartment 18, the battery contacts and wire connections. Other hearing aid components 13 can include for example a microphone, a receiver, a transceiver, an electromagnetic coil, or a circuitry transceiver electromagnetic coil. Vent tube 29, extends through hearing aid 10 including body 11 and faceplate 12.

The pena 19, external ear canal wall 16 and ear canal cavity 15 define the typical human ear. The outside environment (depicted by the numeral 20 in FIGS. 1-3) is room temperature for the preferred embodiment. Body heat shown in FIGS. 1, 2 and 3 transforms the stent from its smaller or deformed size (FIG. 1) to its original pre-molded shape memory size (FIG. 3). The flexible (e.g. silicone) body 11 may act as a bias spring to return the stent 17 to a deformed state when the device 10 has been removed from the ear and exposed to room temperature. Re-insertion of the device 10 into the ear canal 15 returns the device 10 to its original design shape. This property enables ready wear devices to self form to many individual ear canal 15 shapes without the logistics of an ear impression from which to custom mold the device form for that individual ear canal.

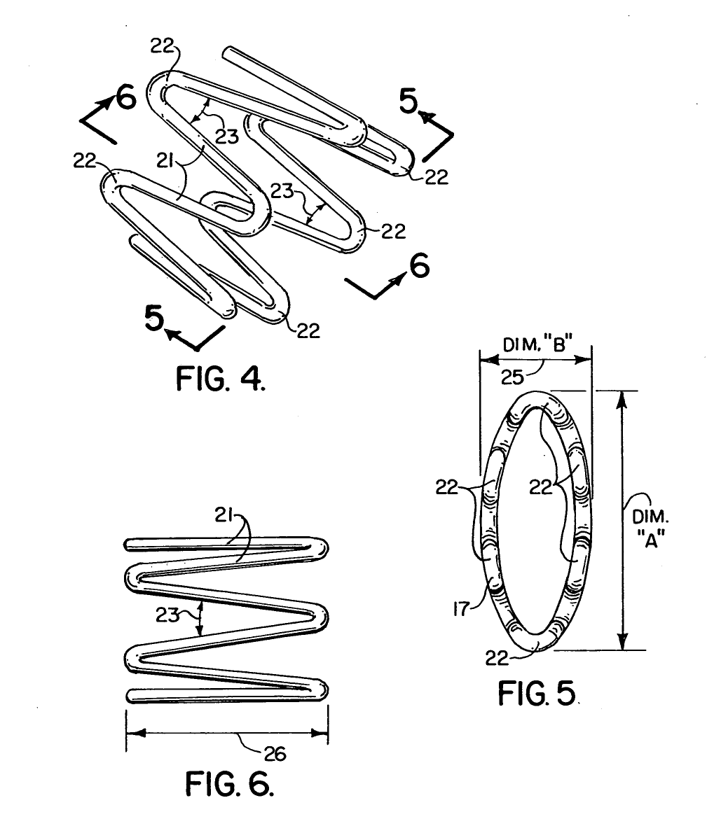

FIGS. 4-6 illustrate the Nitinol stent or frame 17 that can be micro-machined from a cylindrical tube, its preferred outer diameter (OD) FIG. 5 Dim. A (24) is 5-10 mm and Dim. B (25) is 3-9 mm viewed by 6. In FIGS. 4-6, stent 17 includes straight sections 21 connected with curved sections or bends 22. Angle 23 formed by two adjacent straight sections 21 can be between about 15 and 45 degrees. The overall longitudinal length 26 is preferred to be between about 4-8 mm. The cross sectional member depicted in FIG. 6 can be square, round, or rectangular. In the preferred embodiment the thickness is 0.0235 inches each. The cross section may vary in shape and size depending on application and redial force requirements. The geometric angles forming the stent are defined are dependent on redial force requirements and additionally physical dimensions.

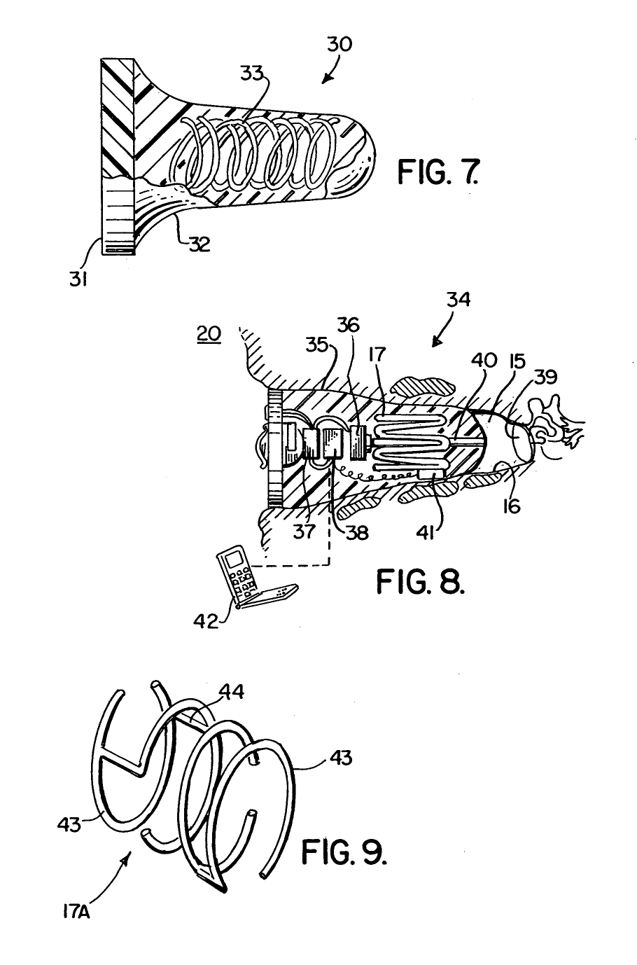

FIG. 7 illustrates a passive hearing protector or “ear plug” designated generally by the numeral 30. The faceplate 31 covering the proximal end of the device is typically plastic bonded to body 32. The silicone body 32 contains a conical or coil spring shape Nitinol spring 33. The device 30 is at room temperature 20 and is in the Martensite phase which is highly malleable. This embodiment would be elongated prior to insertion which reduces the cross sectional area for insertion. At body temperature the coil 33 will retract to its pre-molded austenite shape. In this simplest preferred embodiment illustrated in FIG. 7 in the invention utilizes a coil of similar shape to a spring in an inexpensive ink pen. This circular coil 33 can be extruded in memory metal. The coil 33 can then be shaped into a star configuration in the Martensite phase. This star shaped coil is then molded in a soft-solid silicone body 32 with its electronic components if an active device. The coil 33, or endoskeleton, is placed in the ear worn device 30, such that its longitudinal axis is parallel to the longitudinal axis of the external ear canal or more specifically to the medial-lateral axis of the ear canal. No electronic components are placed between the endoskeleton the external ear canal wall.

In more complex applications, such as the case of hearing devices shown in FIG. 1, the hearing aid components such as a receiver or transducer is housed inside the endoskeleton. In the case of electromagnetic devices, the electromagnetic coil is suspended from a micro machined hinge and gear assembly from the inside diameter of the stent. In both cases, at ear temperature shape memory alloy stent expands outward into its original Austenite shape, causing the soft-solid body of the ear device to move outward into full contact with the ear canal wall of the external ear canal precisely and securely positioning the transducers.

FIG. 8 shows a combination hearing protection and communication device, designated generally by the numeral 34. This complex hearing amplification device 34 provides both a hearing protection device and a communication device housed in a soft body 35. Two transducers are used in concert with a two channel RF transceiver. The acoustic transducer 36 delivers sound from the hearing amplification circuitry 37 delivering processed out side environmental sound and from the two channel transceiver 38 to the ear drum. The stent 17 positions the acoustic transducer 36 aming it at the ear drum 39. The receiver is usually placed lateral to the stent with a port tube 40 extending through the inside of the stent 17 for acoustic sound transmission. The accelerometer 41 is positioned between the out side diameter of the stent 17 and the ear canal wall 16, so that once the stent 17 expands the accelerometer 41 is mechanically engaged to the external ear canal 15 wall 16 allowing it to pick up the wearers voice signals via bone conduction and transmit the voice signals to the transceiver 38. An ultra low power two channel RF transceiver, such as the Gennum Corporation GA3272, optimizes wireless digital audio communication to compatible wireless sensor networks. This apparatus 34 would achieve hearing amplification and hearing protection if desired, as well as enabling voice transmission from the wearer to a communication device (e.g. telephone 42) channeling phone signals back to the ear drum by way of the hearing amplification circuitry 37 via the transceiver 38. The apparatus 34 of FIG. 8 would further serve to protect the hearing of the wearer by an acoustic seal and a limiting circuit in the hearing amplification circuit 37.

In another embodiment of the invention, a stent or skeleton 17A is formed by a series of ribs shown in FIG. 9 is formed by a connected spine, similar to a human rib cage. This horseshoe shaped cross sectional structure is extruded in memory metal. The individual horseshoe shaped elements 43 are connected together by a spine 44 enabling the configuration to act like a plumbing snake during compression i.e. insertion. The spine 44 also maintains the relative spacing of the individual horseshoe shaped elements 43. This ribbed skeleton 17A is then molded in a soft body 12 with its electronic components 13. The skeleton 17A is located medially between the receiver and the proximal end of the soft device. This ear worn device's longitudinal axis is parallel to the longitudinal axis of the external ear canal 15 or more specifically to the medial-lateral axis of the ear canal 15. No electronic components are placed between the endoskeleton and the external ear canal wall. During expansion, pressure is developed on the anterior and posterior surfaces of the ear canal wall. The superior and inferior surfaces are maintained so that at ear temperature, said skeleton expands outward into its original horseshoe shape, causing the soft-solid body of the ear device to move outward into full contact with the ear canal wall of the external ear canal.

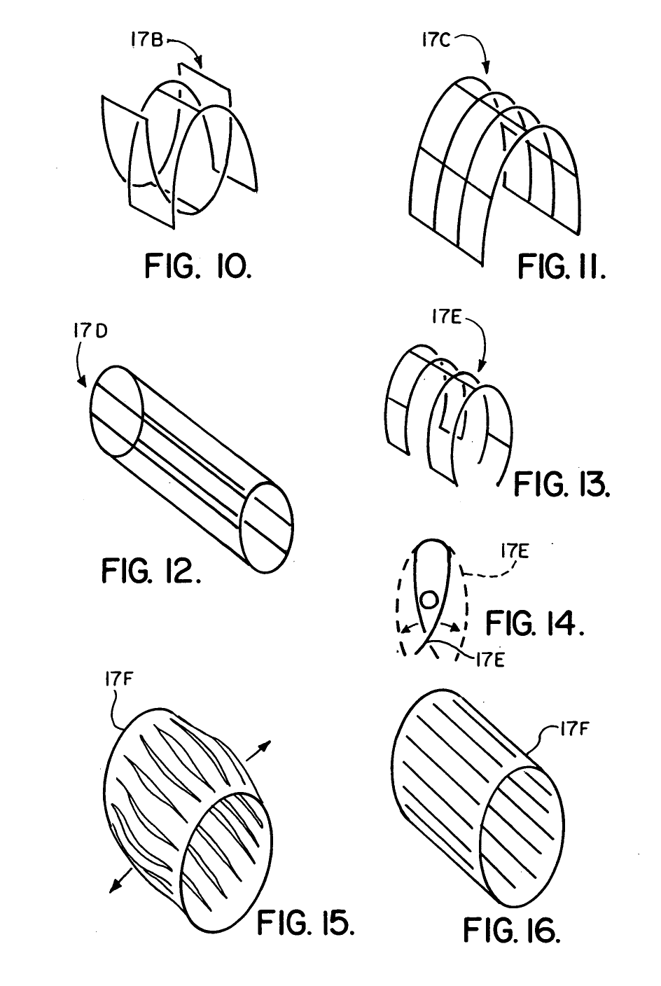

In FIGS. 10-14A various shapes and actions of the stent (designated respectively as 17B, 17C, 17D, 17E, 17F) are shown that would anchor devices for numerous applications in different locations of the external ear canal 15. Any of the preferred geometric configurations of the endoskeleton can be designed and validated through the use of Finite Element Analysis (FEA) modeling. Finite element models are created by breaking the design into numerous discrete members. The models simulate the functionality and mechanical properties covering boundary conditions and the effects on elements such as fields of displacement, strains, stresses, temperatures, state variables, etc. Further, FEA will identify any design are process problems in the earliest time frame.

The following is a list of parts and materials suitable for use in the present invention.

### PARTS LIST

| Part Number | Description |
|---|---|
| 10 | hearing aid |
| 11 | flexible body |
| 12 | faceplate |
| 13 | hearing aid component |
| 14 | ear |
| 15 | ear canal |
| 16 | surface |
| 17 | nitinol stent |
| 18 | battery |
| 19 | pena |
| 20 | outside environment |
| 21 | straight section |
| 22 | curved section |
| 23 | angle |
| 24 | dimension “A” |
| 25 | dimension “B” |
| 26 | length |
| 27 | arrow |
| 28 | arrow |
| 29 | vent tube |
| 30 | hearing protector |
| 31 | faceplate |
| 32 | soft, solid body |
| 33 | coil spring stent |
| 34 | hearing protection and communication device |
| 35 | body |
| 36 | acoustic transducer |
| 37 | circuitry |
| 38 | two channel transceiver receiver |
| 39 | ear drum |
| 40 | tube |
| 41 | accelerometer |
| 42 | mobile telephone |
| 43 | horseshoe shaped element |
| 44 | spine |

All of the above designs eliminate the need for component suspension since they are embedded in soft solid silicone throughout. Vent and sound bores are created by molding leaving a bore without wall space requirements.

All measurements disclosed herein are at standard temperature and pressure, at sea level on Earth, unless indicated otherwise. All materials used or intended to be used in a human being are biocompatible, unless indicated otherwise.

The foregoing embodiments are presented by way of example only; the scope of the present invention is to be limited only by the following claims.

1. A self forming in-the-ear hearing aid, comprising:
a) a hearing aid body that includes an outer soft, compliant wall portion and an interior for holding multiple hearing aid components that enable the hearing aid to amplify sound for a user;
b) a metallic skeleton that is imbedded within the hearing aid body and being positioned to expand the compliant wall portion so that it engages the user's ear canal; and
c) wherein the skeleton is of a metallic construction that expands responsive to temperature that is at or near the temperature of the user's ear canal.

2. The self forming in-the-ear hearing aid of claim 1 wherein the metallic skeleton is of a nitinol material.

3. The self forming in-the-ear hearing aid of claim 1 wherein the metallic skeleton is a mixture of a nickel and titanium.

4. The self forming in-the-ear hearing aid of claim 1 wherein the metallic skeleton is a mixture that includes nickel and titanium.

5. The self forming in-the-ear hearing aid of claim 1 wherein the metallic skeleton is of a material that includes nickel.

6. The self forming in-the-ear hearing aid of claim 1 wherein the metallic skeleton is of a material that includes titanium.

7. The self forming in-the-ear hearing aid of claim 1 wherein the skeleton includes generally U shaped portions.

8. The self forming in-the-ear hearing aid of claim 1 wherein the skeleton includes rounded portions.

9. The self forming in-the-ear hearing aid of claim 1 wherein the skeleton expands at a temperature of about 90-95 degrees Fahrenheit.

10. The self forming in-the-ear hearing aid of claim 1 wherein the skeleton expands at a temperature of above about 90 degrees Fahrenheit.

11. The self forming in-the-ear hearing aid of claim 1 wherein the skeleton expands at a temperature of above about 95 degrees Fahrenheit.

12. The self forming in-the-ear hearing aid of claim 1 wherein the skeleton expands at a temperature at or near a normal human body temperature.

13. The self forming in-the-ear hearing aid of claim 1 wherein the skeleton includes some portions that interconnect with other portions.

14. The self forming in-the-ear hearing aid of claim 1 wherein the skeleton includes some portions of the skeleton that do not touch other portions of the skeleton.

15. A self forming in-the-ear hearing aid, comprising:
a) a hearing aid body that includes an outer movable wall portion and an interior for holding multiple hearing aid components that enable the hearing aid to amplify sound for a user;
b) a metallic skeleton that is connected to the hearing aid body and being positioned to expand the movable wall so that it engages the user's ear canal; and
c) wherein the skeleton is of a metallic construction that expands to expand the wall with it responsive to temperature that is at or near the temperature of the user's ear canal.

16. The self forming in-the-ear hearing aid of claim 15 wherein the metallic skeleton is of a nitinol material.

17. The self forming in-the-ear hearing aid of claim 15 wherein the metallic skeleton is a mixture of a nickel and titanium.

18. The self forming in-the-ear hearing aid of claim 15 wherein the metallic skeleton is a mixture that includes nickel and titanium.

19. The self forming in-the-ear hearing aid of claim 15 wherein the metallic skeleton is of a material that includes nickel.

20. The self forming in-the-ear hearing aid of claim 15 wherein the metallic skeleton is of a material that includes titanium.

21. The self forming in-the-ear hearing aid of claim 15 wherein the skeleton includes generally U shaped portions.

22. The self forming in-the-ear hearing aid of claim 15 wherein the skeleton includes rounded portions.

23. The self forming in-the-ear hearing aid of claim 15 wherein the skeleton expands at a temperature of about 90-95 degrees Fahrenheit.

24. The self forming in-the-ear hearing aid of claim 15 wherein the skeleton expands at a temperature of above about 90 degrees Fahrenheit.

25. The self forming in-the-ear hearing aid of claim 15 wherein the skeleton expands at a temperature of above about 95 degrees Fahrenheit.

26. The self forming in-the-ear hearing aid of claim 15 wherein the skeleton expands at a temperature at or near a normal human body temperature.

27. The self forming in-the-ear hearing aid of claim 15 wherein the skeleton includes some portions that interconnect with other portions.

28. The self forming in-the-ear hearing aid of claim 15 wherein the skeleton includes some portions of the skeleton that do not touch other portions of the skeleton.

29. A method of providing amplified sound to a hearing impaired user, comprising the steps of:
a) providing a hearing aid body that includes a movable wall that is expanded between a first relaxed position and a second extended position responsive to a temperature elevation that occurs inside the user's ear canal;
b) placing the hearing aid body in the user's ear canal when in the relaxed position;
c) leaving the hearing aid body in the user's ear canal until the movable wall moves to the second, extended position.

30. A completely-in-the-canal hearing device having a body including memory metal and soft material for forming an acoustic seal against a user's ear canal wall.

31. A self forming secure ear worn device, comprising:
a) a soft, solid body that includes an outer soft, compliant wall portion and an interior for holding a selected component or components;
b) a metallic skeleton that is imbedded within the body and being positioned to expand the compliant wall portion so that it engages the user's ear canal; and
c) wherein the skeleton is of a metallic construction that expands responsive to temperature that is at or near the temperature of the user's ear canal.

32. The device of claim 31 wherein the self forming secure ear worn device is a hearing aid and the component or components including hearing aid components.

33. The device of claim 31 wherein the self forming secure ear worn device is a hearing protector and the component or components including hearing protector components.

34. The device of claim 33 wherein the protector is a passive device.

35. The device of claim 33 wherein the protector is an active device.

36. The device of claim 31 wherein the device is a communication device.
